(19) United States
(12) Patent Application Publication
(10) Pub. No.: US 2004/0206518 A1
(43) Pub. Date: Oct. 21, 2004

(54) Garden tool

(76) Inventors: Laurene K. Gast, Wichita, KS (US); John J. Gast, Wichita, KS (US)

Correspondence Address: SHOOK, HARDY & BACON LLP, 2555 GRAND BLVD, KANSAS CITY,, MO, 64108, US

(21) Appl. No.: 10/414,914

(22) Filed: Apr. 16, 2003

(51) Int. Cl. A01B 1/00

(52) U.S. Cl. 172/376

(57) ABSTRACT

Disclosed is a garden tool to effectively weed or break up ground in a planting area. The tool has an irregularly shaped metal blade attached to a handle which is extremely effective in working ground. The blade is formed of a metal band and may have holes punched there through in order to increase the aeration of the ground when the soil is worked. The loop shaped band has a flat shaped bottom which is ideal for weeding multiple weeds at one time and covering large surface areas. The blade also has a V-shaped portion which serves to effectively weed gardens in which plants are located close together or to weed in close to a plant without risking killing it. Both edges of the band shaped blade are sharpened to make the weeding process even more effective.

### CROSS-REFERENCE TO RELATED APPLICATIONS

None.

### STATEMENT REGARDING FEDERALLY SPONSORED RESEARCH OR DEVELOPMENT

None.

### BACKGROUND OF THE INVENTION

1. Field of the Invention

The field of the present invention generally is that of garden tools. More specifically, the present invention relates to handheld gardening tools which are used to remove weeds, breakup soil, and also create furrows in which seeds can be planted.

2. Description of the Related Art

When the first garden was created—when the first plot of ground was set aside, toiled, seeded, and watered in hopes that a chosen group of plants might flourish—it is almost certain that this virginal plot was soon thereafter defiled by a loathsome band of undesirables. These undesirable plants would set deep root in that garden. Growing faster and taller than their “chosen” brethren. No brilliantly colored petals. No scent of perfume. Serving only to taint the soil. To block out, choke out, and otherwise ruin the chosen ones—and in doing so dash the gardener's visions of strawberry jam, breeze-blown daffodils, and towering stalks loaded with ears of sweet corn. These original invaders are still in existence today, and commonly referred to as “weeds.”

Initially, the gardener began to fight back. First with his bare hands. The gardener would simply reach down and pull the weed by its above-ground features hoping to get at least enough of the its roots so as to be fatal. But often times the weed would come back. The gardener would have to pull the weed from the ground—first first bending down to clutch the leaves or stem of the weed, and then pulling it out. Repeating these motions for a number of weeds over time would oftentimes cause the gardener's back to tighten, and then ache.

Later, the gardener developed the tool called the “hoe.” The hoe had a long wooden handle and a metal blade. The metal blade extended transversely to the handle. It was effective for removing weeds. The gardener would simply, using the handle for leverage, drive the transverse blade into the soil in advance of the weed. Once the transverse blade was driven into the soil, the handle would be pulled and the earth including the weed would be torn out of the ground by a pulling motion by the gardener. This proved to be effective in removing the weed, however, it also sometimes resulted in damage to the “chosen” plants. This is because the transverse blade tended to be driven so far into the ground, that it would accidentally nick the root systems of the surrounding desirable plants. This would often unintentionally kill these plants. Additionally, because the hoe was removing a large amount of dirt along with the weed, it was very labor intensive because of the amount of force required to pull the hoe back after the blade had been stabbed into the ground.

Next, the gardener developed a hand tool that could be used to remove weeds one at a time effectively. This hand tool consisted essentially of a handle supporting a long metal rod. At the end of the metal rod, was a slightly forked prong. The slightly forked prong was stabbed into the dirt and directed at what the gardener guessed would be the central root portion of the weed. This would cut the central root portion of the weed, which enabled it to be easily pulled out of the ground. This had advantages over the prior method of simply pulling the weeds out of the soil by hand, however, the process was still very labor intensive because it was only possible to remove only one weed at a time. Additionally, it was sometimes difficult to “find” the root under the ground with the forked prong end.

Next, the gardener developed what is commonly known as the “hula hoe.” The hula hoe had an elongated wooden handle with a blade at one end. The blade of the hula hoe is essentially a metal band that is bent into a trapezoidal shape. This metal band shaped blade is angled obtusely downward and hinged to the end of the handle. Though the blade is hinged, the articulation of the blade about its access is restricted so that the blade, though it may move slightly about its access, always remains substantially obtusely downward from the end of the handle. The downward most edge of the blade is what is used for weeding. In use, the hula hoe blade is placed in advance of the weed, or weeds desired for removal, and pulled back towards the user—much like the action used for the hoe—except that the blade of the hula hoe, because of its orientation, slices into the ground as the user pulls the handle back and cuts the weed off at its root slightly below the surface of the soil. This of course can be used to remove multiple weeds at once. The angle of the cutting surface of the hula hoe blade is substantially parallel to the ground, however, slightly angled into the ground. This results in the blade only entering the ground approximately a half inch to an inch. This makes it unlikely that the blade will sink deep enough into the soil to actually damage the root systems of the plants that are desired to be in the garden. Additionally, the hula hoe was much easier to operate than the traditional hoe, because it did not actually remove any of the ground, rather sliced through the ground, making it much easier to pull back.

But even considering these advances made over the prior art by the hula hoe, it still has many disadvantages. Though it is effective in removing weeds from open areas in a garden (those areas not close to a plant), it is not as effective in removing weeds that are close to a plant. This is for two reasons. First, it is very risky to weed a close in plant with a hula hoe, because any error in judgment could also sever the plant along with the weed. Second, because the hula hoe is used with a long handle, the gardener is not able to get a close up look at the location of the weed which also increases the risk that the plant might accidentally be severed along with the weed. Third, the trapezoidal shape of the metal band blade is not designed for close in weed removal. Because of these drawbacks, gardeners often use a hula hoe for limited purposes, only removing weeds in open areas, but still pull weeds by hand if they are close to any desirable plant in the garden. This causes undesirable delays and unnecessary extra effort. Another undesirable aspect of the hula hoe, is that its metal band blade is solid, without any irregularities. This limits its ability to effectively aerate the soil, because besides its slicing capabilities, it does not at the same time additionally aerate the soil.

There is a need in the art for a garden tool which has the advantages of the hula hoe in terms of ease of weeding, but that may also be used for close in situations as described above. There is also a need for a garden tool with superior aeration which in addition to effectively weeding, can also effectively aerate the soil while the weeding is accomplished. The garden tool of the present invention accomplishes these objectives.

### SUMMARY OF THE INVENTION

The garden tool of the present invention is extremely effective in removing weeds. Especially where these weeds are located in and around plants which the gardener wishes to spare. It is also more effective at aerating the soil as the gardener is weeding. Additionally, the tool may be used to furrow rows for the gardener to seed.

Structurally speaking, the present invention is a short-handled garden tool having a band shaped blade which is bent so that one end of the blade is tight V-shaped, whereas the opposing end is well rounded. The blade is also bent so that it has a flat-shaped cutting portion with sharpened opposing sides.

The V-shaped portion of the blade serves dual purposes. First, it can be used to weed especially tight spots around a plant. Second, it may be used to create a furrowing row in order that seeds may be dropped in it. Another objective of the garden tool of the present invention is that the blade defines a plurality of the regularly sized holes along its length. These holes serve to meet the objective of sufficiently aerating the soil when the device is used for weeding.

### BRIEF DESCRIPTION OF THE DRAWING

The present invention is described in detail below with reference to the attached drawing figures, wherein:

FIG. 1 shows a perspective view of the garden tool.

FIG. 2 shows a side view of the garden tool of the present invention.

FIG. 3 shows a cross sectional view of the blade of the garden tool which depicts the sharpened opposing edges of the blade.

FIG. 4 shows a view of the blade from the bottom of the tool.

### DETAILED DESCRIPTION OF THE INVENTION

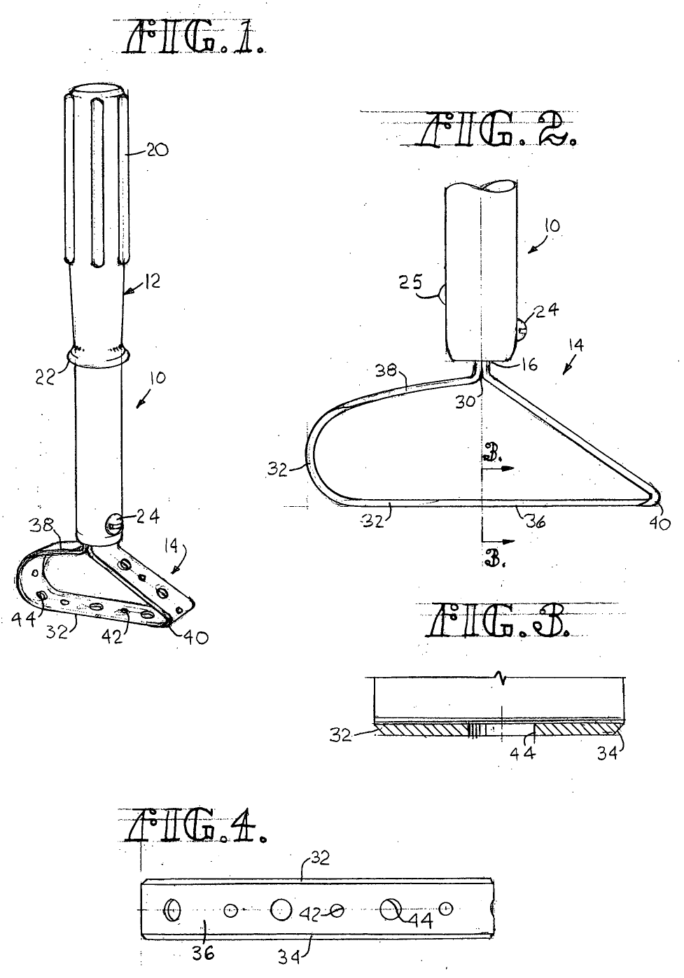

The details of the garden tool of the present invention are shown in FIGS. 1-4. Referring first to FIG. 1, tool 10 comprises a handle 12 and a blade 14. Handle 12 is preferably from 6 inches to 24 inches in length, but could be made shorter or longer if desired. The handle of the preferred embodiment is composed of plastic, however, wood, metal or any other physically acceptable material would fall within the scope of the invention. As shown in FIG. 1, handle 10 comprises a grip portion 20, a protruding ridge 22 and a pair of screws, 24 and 25. Screws 24 and 25 are used to attach blade 14. Alternatively, a single screw could be used.

How the blade is attached to the handle is best shown in FIG. 2. Referring to the Figure, in order for the blade 14 (which is essentially a metal band) to be installed into the handle 12, the ends of the band 14 are inserted into a slot 16 (not shown in detail, but is simply a slot machined into the handle 12 designed to snugly fit the ends of the band within it). When the bands are inserted into slot 16, a zone of engagement 30 is formed there between. Screws 24 and 25 are each received in a bored hole in the handle (not pictured). These screws compressibly hold the ends of the band within the handle firmly.

FIG. 2 also shows the details of the tool blade. From the Figure it can be seen that the band blade 14 is formed into what is essentially a carrot shape. One part of the blade is bent to form a larger hemispherical portion 37. The bottom part of the blade, which is used for weeding large swatches of weeds from the soil, is formed into a flat portion 36 which is designed to evenly clip multiple weeds. The other end of the blade 40 forms into a narrow V. This V-shaped portion 40 is what is used to weed or aerate in close to plants or other object. The edges of the blade, 32 and 34 respectively, are shown in FIGS. 3 and 4. From FIG. 3 it can be seen that both sides of flat portion 36 are sharpened, coming to a point which serves as a cutting edge. Referring now back to FIG. 2, it can be seen that this sharpened edge is not limited only to flat portion 36 on the bottom of the blade (both sides). Rather, it also extends up on much of the semi-circular portion 37. It has been found that this sharpened portion of the blade is useful for digging at hardened soil.

Because both sides of the blade are sharpened, the user may be used to weed in either direction, if such is desired. This makes the tool especially useful for weeding in close to a plant, because coming at the weed from a particular direction or angle is often important to avoid “nicking” the root system or stem of the plant. Additionally, the double-sharp-edged design makes the tool is equally useable for left and right handed persons.

FIG. 4 shows the aerating features of the present invention in detail. These features appear as two alternating sets of holes, 42 and 44. One set 42 is smaller than the other 44. It has been found during the processes of weeding or breaking up the soil, that these holes serve to aerate the ground which is advantageous when the ground is used to grow plants.

V-shaped portion 40 of the blade, serves dual purposes. In addition to the aforementioned purpose of allowing weeding in close proximity to plants, the V-shaped portion 40 may also be used to create a furrowing row in which seeds may be planted. During this furrowing process, after a row is created with the V-shaped portion and the seeds are dropped in, the row may be buried using the flat portion of the blade.

It is important to note that the materials of which the tool is composed are not considered to be limiting for purposes of the present invention. The handle, though in this disclosed preferred embodiment is composed of hard thermal plastic, other materials could also be used, say for example, wood or metal. Though the blade used in the garden tool of the present invention is composed of steel, other materials could also be used. The blade of the preferred embodiment of this present invention and the one shown in FIGS. 1-4, is made of a bendable steel. The steel used in making the band is selected such that it is sufficiently bendable during the manufacture process in order to create the V-shaped portion and enable the sharp bends below the zone of engagement. However, the steel selected should not be so bendable that a user will have problems with the blade coming out of shape when it is used in the garden and its durability is challenged by, i.e., a rock.

It is also important to note that the blade and handle could both be comprised of a thermal plastic material that was of sufficient hardness to meet the requirements consistent with the performance needs of the garden tool. In such cases the handle could even be formed integral with the blade.

Additionally, it is important to note that many variations and alterations could be made regarding the garden tool which would still fall within the scope of the invention. That invention is what is defined by the claims below.

1-13. (cancelled)

14. A garden tool comprising:
a handle;
a blade fixed to said bottom end defined by a band, said band forming a loop;
said loop extending substantially transversely from said handle in first and second opposite directions;
said loop and having a V-shaped cross section in a first direction; and
said loop having a rounded cross section in said second direction.

15. The garden tool of claim 14 wherein said loop has a substantially flat bottom portion.

16. The garden tool of claim 15 wherein said V-shaped cross section is defined from below by said flat bottom portion and from above by a substantially planar portion which slopes downward from said handle.

17. The garden tool of claim 15 wherein said V-shaped portion is configured to define an angle which is substantially less than 80 degrees.

18. The garden tool of claim 14 wherein said blade has forward and rear edges, at least one of which is sharpened.

19. The garden tool of claim 14 in which a first set of holes are defined through at least a portion of said blade.

20. The garden tool of claim 19 in which a second set of holes smaller than those of said first set are also formed through said blade, and wherein each of said smaller holes of said second set are interposed between each of said holes of said first set.

21. The garden tool of claim 14 above, wherein said handle is elongated and has a length of between 6 inches and 24 inches.

22. A garden tool comprising:
a substantially elongated handle having a top end and a bottom end; and
a blade fixed to said bottom end defined by a band, said band forming a loop;
said loop defining:
a substantially flat bottom portion for use in weeding or aerating areas in which desired plants are more spread apart;
a converging portion for use in weeding or aerating areas in which the desired plants are more closely oriented, or for use in weeding or aerating in close proximity to the one of said desired plants; and
a rounded portion for use in weeding or aerating mid-sized areas.

23. The tool of claim 22 wherein said converging portion has a V-shaped cross section.

24. The tool of claim 22 wherein said blade has forward and rear edges, at least one of which is sharpened.

25. The tool of claim 22 in which portions of said band have a first set of holes therethrough for aerating the soil.

26. The tool of claim 25 having a second set of smaller holes, each of said smaller holes being between a hole of said first set of holes.

27. The tool of claim 22 wherein said handle is between 6 inches and 24 inches of length.

28. A garden tool comprising:
a handle having a top and a bottom;
a blade fixed to said bottom end defined by a band;
said band forming a loop; and
said loop having a first set of holes there through, said holes serving to aerate soil.

29. The tool of claim 28 wherein said loop extends substantially transversely from said handle in first and second opposing directions.

30. The garden tool as defined by claim 28 in which a second set of smaller holes are interposed between each pair of holes defined by said first set of holes.

31. The tool of claim 28 wherein said loop has a substantially flat bottom portion.

32. The tool of claim 31, wherein a V-shaped cross section is defined from below by said flat bottom portion and from above by a substantially planar portion which slopes downward from said handle.

33. The tool of claim 32, wherein said V-shaped cross section is angled at substantially less than 80 degrees.
